(19) United States
(12) Patent Application Publication
(10) Pub. No.: US 2008/0150331 A1
(43) Pub. Date: Jun. 26, 2008

(54) Seat assembly of body-building machine

(76) Inventor: Chao-Chuan Chen, Taichung (TW)

Correspondence Address: CHAO-CHUAN CHEN, 235 Chung - Ho, Box 8-24, Taipei, omitted

(21) Appl. No.: 11/645,338

(22) Filed: Dec. 26, 2006

(51) Int. Cl. B62J 1/00

(52) U.S. Cl. 297/195.11

(57) ABSTRACT

A seat assembly of a body-building machine comprises a seat portion having a cushion and a seat tube combined to a lower side of the cushion; a retaining seat having a hollow portion at a lower side thereof; the hollow portion having a plurality of embedding grooves; each embedding groove having an inclined lower lateral surface so that an inner space of each embedding groove having a larger upper space and a small lower space; each retaining seat having a roller installed therein; an adjusting tube installed within the hollow portion of the retaining seat; an outer side of the adjusting tube having a plurality of slots; the number and arrangement of the penetrating slots being corresponding to those of the embedding grooves of the retaining seat; and a stop being installed at an upper side of the adjusting tube and resisting against an upper side of the retaining seat.

### FIELD OF THE INVENTION

The present invention relates to body-building machines, and particularly to a seat assembly of a body-building machine, wherein no screw us used and the seat portion of the machine can be firmly secured. The adjustment of the elevation of the seat portion can be positioned easily.

### BACKGROUND OF THE INVENTION

In current seat of a body-building machine, the adjustment of a seat is performed by adjusting a screw from one hole to another hole. The adjustment is not firmly so that it can not suffer from great and long period vibrations, especially, at the time that the user uses the body-building machine. Even for a long time, it is possible that the seat can not be firmly secured so that the user hurts. Moreover, it is possible that the screws for locking the seat are lost so as to make trouble to the users.

### SUMMARY OF THE INVENTION

Accordingly, the primary object of the present invention is to provide a seat assembly of a body-building machine, wherein no screw us used and the seat portion of the machine can be firmly secured. The adjustment of the elevation of the seat portion can be positioned easily.

To achieve above objects, the present invention provides a seat assembly of a body-building machine which comprises a seat portion having a cushion and a seat tube combined to a lower side of the cushion; a retaining seat having a hollow portion at a lower side thereof; the hollow portion having a plurality of embedding grooves; each embedding groove having an inclined lower lateral surface so that an inner space of each embedding groove having a larger upper space and a small lower space; each retaining seat having a roller installed therein; an adjusting tube installed within the hollow portion of the retaining seat; an outer side of the adjusting tube having a plurality of slots; the number and arrangement of the penetrating slots being corresponding to those of the embedding grooves of the retaining seat; and a stop being installed at an upper side of the adjusting tube and resisting against an upper side of the retaining seat. The seat tube of the seat portion is placed into the adjusting tube. By the longitudinal movement of the adjusting tube, the rollers in the embedding grooves slide in the embedding grooves so that the elevation of the seat portion is adjustable.

The various objects and advantages of the present invention will be more readily understood from the following detailed description when read in conjunction with the appended drawing.

### BRIEF DESCRIPTION OF THE DRAWINGS

FIG. 1 is an exploded perspective view of the seat assembly of a body-building machine of the present invention.

FIG. 2 is a schematic cross sectional view about the seat assembly of a body-building machine of the present invention.

FIG. 3 is a schematic perspective view about the operation of the seat assembly of a body-building machine of the present invention.

FIGS. 4 to 6 are lateral schematic views bout the operation of the seat assembly of a body-building machine of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

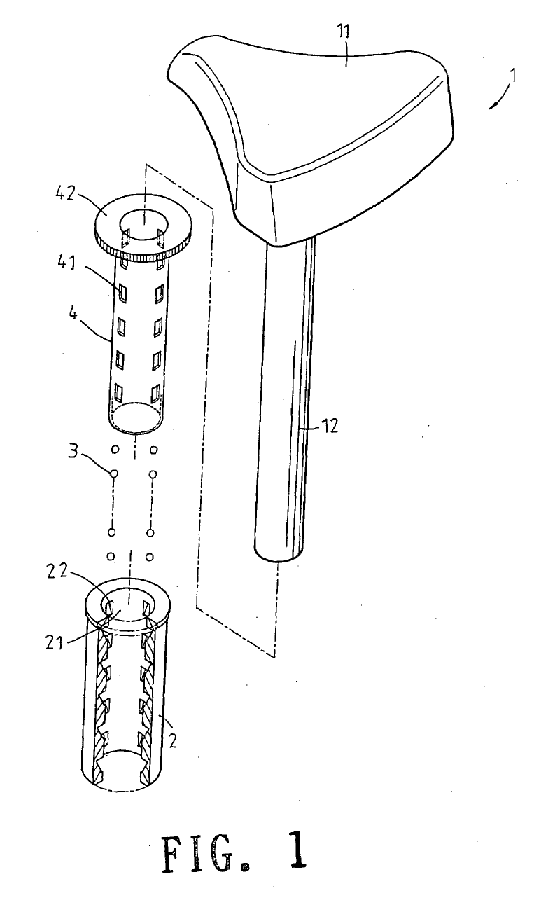

Referring to FIG. 1, the seat assembly of a body-building machine of the present invention is illustrated. The present invention has the following elements.

A seat portion 1 has a cushion 11 and a seat tube 12 combined to a lower side of the cushion 11.

A retaining seat 2 has a hollow portion 21 at a lower side thereof. The hollow portion 21 has a plurality of embedding grooves 22. Each embedding groove 22.has an inclined lower lateral surface so that an inner space of each embedding groove 22 has a larger upper space and a small lower space. The embedding grooves 22 are arranged as two parallel longitudinal banks. Each retaining seat 2 has a roller 3 installed therein. In this embodiment, the roller 3 is a rolling ball. However, the roller 3 may be a rolling needle.

The adjusting tube 4 can be placed into the hollow portion 21 of the retaining seat 2. An outer side of the adjusting tube 4 has a plurality of slots 22. The number and arrangement of the penetrating slots 22 are corresponding to those of the embedding grooves 22 of the retaining seat 2. A stop 42 is installed at an upper side of the adjusting tube 4 and resists against an upper side of the retaining seat 2.

By above mentioned structure, the seat tube 12 of the seat portion 1 is placed into the adjusting tube 4. By the longitudinal movement of the adjusting tube 4, the rollers 3 in the embedding grooves 22 slide in the embedding grooves 22 so that the user can adjust the height of the seat portion 1.

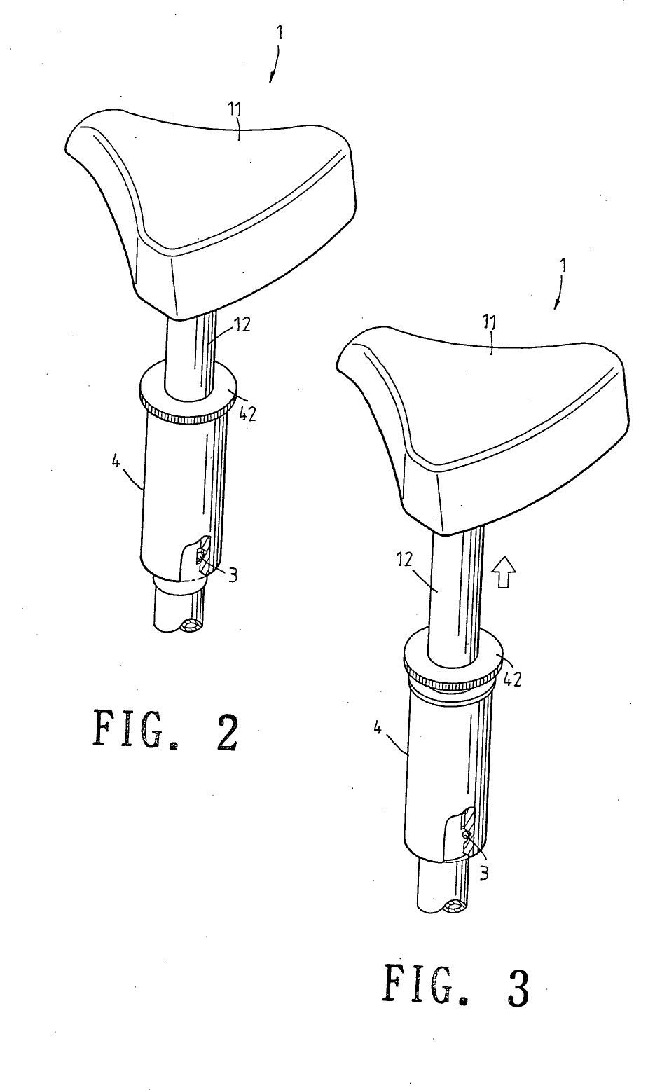

Referring to FIGS. 2 to 5, the adjustment of the body-building machine according to the present invention is illustrated.

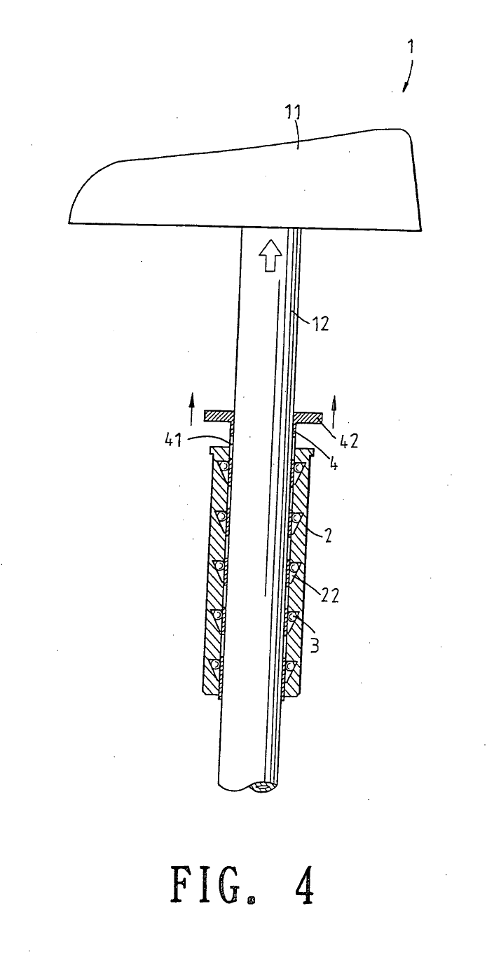

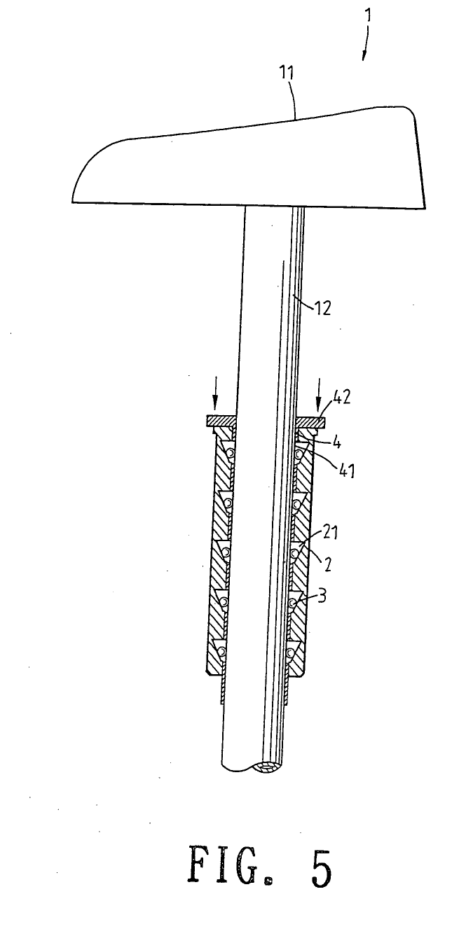

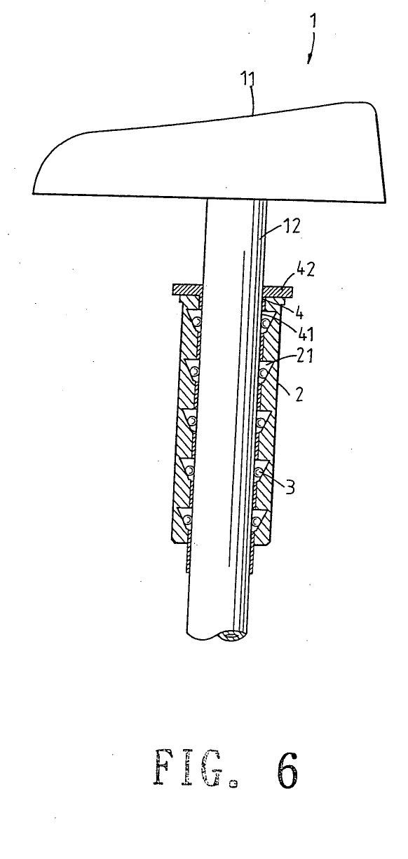

When user desires to adjust the seat portion 1, the user pulls the stop 42 upwards so that the rollers 3 in the embedding grooves 22 will move to an upper side of the embedding grooves 22 which has a larger size (FIG. 4). Thus the user can adjust the seat portion 1 to a desired height. Then, the stop 42 of the adjusting tube 4 is pressed downwards. The rollers 3 in the embedding grooves 22 will slide to lower narrow portions of the embedding grooves 22 (FIG. 5) to be arranged in the slots 41 of the adjusting tube 4. Thus the seat tube 12 is firmly secured. The retaining seat 2 will firmly secure the adjusting tube 4 even the seat portion 1 is greatly vibrated, it is still located firmly.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A seat assembly of a body-building machine comprising:
a seat portion having a cushion and a seat tube combined to a lower side of the cushion;
a retaining seat having a hollow portion at a lower side thereof; the hollow portion having a plurality of embedding grooves; each embedding groove having a inclined lower lateral surface so that an inner space of each embedding groove having a larger upper space and a small lower space; each retaining seat having a roller installed therein;
an adjusting tube installed within the hollow portion of the retaining seat; an outer side of the adjusting tube having a plurality of slots; the number and arrangement of the penetrating slots being corresponding to those of the embedding grooves of the retaining seat; a stop is installed at an upper side of the adjusting tube and resists against an upper side of the retaining seat;
wherein the seat tube of the seat portion is placed into the adjusting tube; by the longitudinal movement of the adjusting tube, the rollers in the embedding grooves slide in the embedding grooves so that the elevation of the seat portion is adjustable.

2. The seat assembly of a body-building machine as claimed in claim 1, wherein the embedding grooves are arranged as parallel longitudinal banks.

3. The seat assembly of a body-building machine as claimed in claim 1, wherein the rollers move in the embedding grooves due to the movement of the adjusting tube.

4. The seat assembly of a body-building machine as claimed in claim 1, wherein the roller is a rolling ball or a rolling needle.

5. The seat assembly of a body-building machine as claimed in claim 1, wherein the stop is installed at an upper side of the adjusting tube and resists against an upper side of the retaining seat.
